(19) United States
(12) Patent Application Publication
(10) Pub. No.: US 2024/0385439 A1
(43) Pub. Date: Nov. 21, 2024

(54) MIRROR DEVICE FOR A HEAD-UP DISPLAY COMPRISING A SPECIFIC ROTARY BEARING BETWEEN A CARRIER AND A SEPARATE BEARING UNIT, AND HEAD-UP DISPLAY AND MOTOR VEHICLE

(71) Applicant: VALEO SCHALTER UND SENSOREN GMBH, Bietigheim-Bissingen (DE)

(72) Inventor: Loic Le Toumelin, Bietigheim-Bissingen (DE)

(73) Assignee: VALEO SCHALTER UND SENSOREN GMBH, Bietigheim-Bissingen (DE)

(21) Appl. No.: 18/690,026

(22) PCT Filed: Sep. 5, 2022
(86) PCT No.: PCT/EP2022/074574

§ 371 Date: Mar. 7, 2024

(30) Foreign Application Priority Data
Sep. 8, 2021 (DE) 10 2021 123 187.6

(51) Int. Cl. G02B 27/01; B60K 35/23

(52) U.S. Cl. CPC G02B 27/0149; B60K 35/23; G02B 27/0101; B60K 2360/23; G02B 2027/0154

(57) ABSTRACT

A mirror device for a head-up display is disclosed. The mirror device includes a mirror, a carrier arranged on a rear side of the mirror, and a bearing unit separate from the carrier. The bearing unit is connected to the carrier by at least one rotary bearing. The carrier and the bearing unit when coupled by the rotary bearing are rotatable relative to each other. The rotary bearing includes at least one bearing journal and at least one bearing chamber with opposite bearing walls. The bearing journal is arranged between the bearing walls of the bearing chamber and engages in bearing journal receptacles which are formed in the bearing walls such that the bearing journal is rotatably mounted on both bearing walls and an axis of rotation of the rotary bearing runs through the bearing journal receptacles.

One aspect of the invention relates to a mirror device for a head-up display of a motor vehicle. The mirror device has a mirror. The mirror has a rear side. In addition, the mirror device has a carrier which is separate from the mirror. The carrier is fixedly connected to the mirror. In addition, the mirror device has a bearing unit which is separate from the carrier. The bearing unit is connected to the carrier by at least one rotary bearing. The carrier and the bearing unit when coupled by the carrier are rotatable relative to each other. Another aspect of the invention relates to a head-up display with a mirror device. Yet another aspect of the invention relates to a motor vehicle with a head-up display.

Head-up displays in motor vehicles usually have a housing. This can be formed from a plurality of subregions. In this context, it can have a cover module and a base module, for example. These two components can be joined together. Plug connections or snap connections or screw connections and the like can be provided here, for example. In this regard, the cover module has an outer housing. The base module can likewise have an outer housing. These two parts in the form of the outer housings or the shells then also form the overall housing of the head-up display. In this regard, they are therefore external visible components of the head-up display. An image generation unit is usually arranged in a head-up display. This generates the images, which can be projected by means of the head-up display onto an external projection surface, such as a window pane of the motor vehicle. In addition, a head-up display has at least one mirror in the interior of the housing. The light beams generated by the image generation unit are reflected by this mirror. In head-up displays, it is also possible, however, to envisage the installation of two separate mirrors in the interior of the housing. As a result, multiple deflection or multiple reflection of the light beams generated by the image generation unit is performed. In this case, a first mirror, which is arranged closer to the image generation unit in the beam path from the image generation unit to an exit window of the head-up display, is also referred to as a fold mirror. With the second mirror arranged downstream of the beam path with respect thereto, the light beams are deflected, in particular toward this exit window of the head-up display. To enable the light deflection and thus also the light emission to be performed very precisely, and since sharp image representation is therefore also possible, a very precise arrangement of the mirrors in the housing, in particular of a mirror which is first in this regard, is required.

A reflection device for a head-up display is known from DE 10 2019 120 466 A1. The reflection device therein has a reflection element in the form of a mirror. Adhesive pads are attached to a rear side of said mirror. Separate supporting structures are arranged on these in turn. A plate-like carrier is coupled to said supporting structures. Said carrier has bearing journals. A central thickening of said bearing journals is inserted into a bearing receptacle of a supporting structure. So that the bearing journal can be held in said bearing receptacle, an additional separate plate-like securing element is provided, which covers the bearing receptacle at the front. The bearing journal with its central thickening is accommodated lying against the inner walls of the bearing receptacle only at points and not so as to be self-supporting therein.

It is an object of the present invention to provide a mirror device for a head-up display, in which the rotatable connection between a carrier and a bearing unit of the mirror device is improved. Furthermore, it is an object to provide a head-up display with a corresponding mirror device. It is also a further object to provide a motor vehicle with a corresponding head-up display.

One aspect of the invention relates to a mirror device for a head-up display of a motor vehicle. The mirror device has a mirror. The mirror has a rear side. In addition, the mirror device has a carrier which is separate from the mirror. The carrier is fixedly connected to the mirror. In addition, the mirror device has a bearing unit which is separate from the carrier. The bearing unit is connected to the carrier by at least one rotary bearing. The carrier and the bearing unit when coupled by the carrier are rotatable relative to each other.

The rotary bearing has at least one bearing journal and at least one bearing chamber. The bearing chamber has opposite bearing walls arranged spaced apart from each other. When coupled between the bearing journal and the bearing chamber, the bearing journal is arranged between the bearing walls of the bearing chamber. The bearing journal is then in direct contact with both bearing walls. The bearing walls each have at least one bearing journal receptacle. The bearing journal receptacles are thus formed in the bearing walls. The bearing journal engages in said bearing journal receptacles. The bearing journal is therefore directly mounted rotatably on both bearing walls. The bearing journal is arranged on the bearing walls in a self-supporting manner. The self-support is achieved, in particular, only by the direct coupling to the bearing walls. An axis of rotation of the rotary bearing is arranged running through the two bearing journal receptacles.

On the one hand, the coupling between the carrier and the bearing unit is improved by such a rotary bearing. A mechanically more stable and component-reduced design of the rotary bearing is thus possible. However, in this context, a more precise rotational movement possibility in relative terms between these two components, namely the carrier and the bearing unit, is also particularly advantageous. Since the bearing journal is now coupled to the bearing chamber, in particular to the bearing walls, at at least two separate bearing points, the bearing journal is also mounted more stably in this respect. The bearing points on the separate bearing walls are furthermore designed such that the axis of rotation runs exactly through said two bearing points. Since the bearing journal, as viewed in the direction of said axis of rotation, has opposite coupling regions, which are coupled to said bearing journal receptacles, a multi-point mounting of the bearing journal is thus also formed. This will further support the advantages mentioned above. In this context, it is then also no longer necessary for an additional covering or the like, as provided in the prior art, to be required. Owing to the multi-point mounting of the bearing journal itself on separate bearing walls of the bearing chamber, the bearing journal is also arranged on the bearing chamber in a self-supporting manner. In this connection, the bearing journal is arranged at least in regions in the bearing chamber when coupled to the bearing journal receptacle. This also achieves a compact design. In this connection, the entire bearing journal is also arranged in a more protected manner.

In the exemplary embodiment, the bearing journal is therefore arranged, as viewed in the direction of the axis of rotation, between the bearing walls and is mounted directly on the bearing walls at the two bearing points. Position tolerances between the bearing journal and the bearing walls can therefore also be better avoided. The rotational movement of the bearing journal relative to the bearing walls is thus also further improved and, in particular, made possible with greater precision. This also provides significant advantages in terms of the precise position adjustment of the mirror itself

In one exemplary embodiment, the bearing journal receptacles are formed as continuous holes in the bearing walls. This also allows the bearing journal to extend as far as possible into a bearing journal receptacle. In particular, it can extend in this respect at least over the thickness of a bearing wall into said bearing journal receptacle. It is also possible to extend through such a bearing journal receptacle in regions. A coupling region in this respect of a bearing journal is thus arranged in the coupled state on both sides of said bearing journal receptacle. In one exemplary embodiment, a bearing journal receptacle is in the form of a peripherally closed hole. This means that the contour of a bearing journal receptacle in the peripheral direction around the hole axis of said bearing journal receptacle is completely closed. As a result, in particular, a peripherally closed contour edge is also formed. This is another highly advantageous exemplary embodiment for being able to mount the bearing journal in a stable and tolerance-minimized manner on the bearing walls.

In one exemplary embodiment, the bearing walls are elastically deformable, as viewed in the direction of the axis of rotation. This is another highly advantageous exemplary embodiment. This is because the bearing journal can thereby be easily installed on the bearing walls. By simply pushing or pressing the bearing journal into the bearing chamber, the bearing walls can be pushed outward elastically by the bearing journal protruding in this respect over the clear width between the bearing walls. However, the bearing journal may also be pushed further into the bearing chamber until it engages with its opposite coupling regions in the opposite bearing journal receptacles. This engagement makes it then possible for the outwardly bent bearing walls to move back again elastically into their basic position. The coupled state is thus also kept particularly stable. Owing to this partially elastic deformability of the bearing walls, a very simple and rapid installation concept is also achieved.

In one exemplary embodiment, when viewed in the direction of the axis of rotation, the bearing journal has end-side bearing pins. These may be exemplary embodiments for corresponding coupling regions of the bearing journal. Said opposite end-side bearing pins, which are freely protruding in this context in the direction of the axis of rotation, make it possible to achieve a particularly advantageous coupling and engagement in the bearing journal receptacles. In the mounted end state, said end-side bearing pins each extend at least in regions, when viewed in the direction of the axis of rotation, into the bearing journal receptacles in the bearing walls. This coupling alone, and these two elements alone, namely the bearing walls, on the one hand, and the bearing journal, on the other hand, enable a direct preferred coupling without the need for additional holding elements, closure elements or cover elements.

In one exemplary embodiment, the bearing pins are received in the bearing journal receptacles in a form-fitting manner. This means in particular that an outside, in particular a casing side of a bearing pin, lies in a form-fitting manner against a boundary edge or contour edge of a bearing journal receptacle. Preferably, this is formed completely peripherally around the hole axis of the bearing journal receptacle. A form-fitting concept of this type permits a particularly stable mechanical mounting with particularly precise rotational movement guidance. This enables a very tolerance-minimized mounting concept.

In one exemplary embodiment, a bearing pin is cylindrical. In particular, the bearing pin is arranged lying with its casing wall or with the cylinder wall in a form-fitting manner against a contour edge of the bearing journal receptacle. In particular, this applies to both bearing pins of the bearing journal with regard to their coupling to the bearing journal receptacles.

In one exemplary embodiment, at least one bearing pin is tapered at its outer and thus also free end, when viewed in the direction of the axis of rotation. In particular, a conical configuration of said outer end may be provided here. This geometry of the bearing pin permits particularly easy coupling to the bearing journal receptacle. This is because such an obliquely angled chamfer makes it easier to insert the bearing journal into the bearing chamber, and for the outward bending of the bearing walls to be able to be carried out continuously with the insertion of the bearing journal into the bearing chamber. Jamming or spreading in this regard can be avoided. Likewise, such a tapered shaping of an outer end of a bearing pin also allows a more jamming-free and continuous insertion of a bearing pin into a bearing journal receptacle.

In one exemplary embodiment, at least one bearing pin has a stop. This stop limits the immersion depth, as measured in the direction of the axis of rotation, of the bearing pin into a bearing journal receptacle. This also favorably assists the axial mounting and thus the mounting in the direction of the axis of rotation of the bearing journal on the bearing walls. A particularly central arrangement of the bearing journal between the bearing walls is thus made possible and permanently maintained. Last but not least, this also positively assists the rotational movement guidance. Such a stop is thus a protrusion, when viewed in a direction perpendicular to the axis of rotation.

In one exemplary embodiment, a guide device for guiding the bearing journal when it is inserted into the bearing chamber is formed on an inside of at least one bearing wall. This means in particular that even if corresponding spreading forces of the bearing journal act on the bearing walls and elastically deform them outward, a guided movement of the bearing journal into the end position is assisted. By means of the guide device, a targeted displacement of the bearing journal in the bearing chamber can also be carried out in this state until the end position therein is reached. In said end position, the bearing pins of the bearing journal then engage in the bearing journal receptacles.

In one exemplary embodiment, the guide device has guide paths along which subregions of the bearing journal lie and are correspondingly guided in order to reach the defined end position in the bearing chamber. The guide paths are integrated in the insides of the bearing walls.

In one exemplary embodiment, the guide device has an end edge. The end edge predetermines the end position of the bearing journal in the bearing chamber. In said end position, the bearing journal is clipped into the bearing journal receptacles. In particular, this also means that the at least two bearing pins of the bearing journal are snapped into the respective bearing journal receptacles. Such a concept with corresponding clipping or snapping into place is particularly advantageous. This is because, on the one hand, a very simple installation of the bearing journal on the bearing walls can thus be achieved; on the other hand, a particularly advantageous and mechanically stable coupling state between the bearing journal and the bearing walls can thus be automatically generated and maintained in the end position. Such a clipping or snapping into place is a mechanically highly functional operating principle.

In one exemplary embodiment, the bearing journal is in the form of a clip-in element or snap-in element which is clipped or snapped into the bearing journal receptacles. This then also means that the bearing journal, in particular the bearing pins, is/are arranged overlapping with the bearing walls, when viewed in the direction of the axis of rotation.

In one exemplary embodiment, the mirror device has a spring. In one exemplary embodiment, the spring, which is separate in this respect, is arranged between the carrier and the bearing unit. A position between the carrier and the bearing unit is preloaded by this spring, in one exemplary embodiment. This enables the relative movement between the carrier and the bearing unit to be assisted as an addition to the provided rotary bearing.

In one exemplary embodiment, the mirror device has two separate rotary bearings. The two rotary bearings are arranged spaced apart from each other. In particular, they are identically constructed. This means that the above-mentioned advantageous exemplary embodiments of a rotary bearing are then also equally applicable to the second rotary bearing in this advantageous exemplary embodiment. In one exemplary embodiment, the axis of rotation runs through both rotary bearings. As a result, the mechanically stable mounting, on the one hand, and the rotational movement possibility in relative terms between the carrier and the bearing unit, on the other hand, are further improved. Both the mechanical stabilization and the precision of the rotational movement are thereby further increased.

In one exemplary embodiment, the bearing journal is formed as one piece. In particular, this means that it is also produced in one piece during a production process. For example, the bearing journal may be made of plastic. In particular, it may be an injection molding component.

The bearing journal may be an integral part of the bearing unit. The bearing unit may be designed as an elongate rail. When viewed in the direction of the longitudinal axis of said rail, bearing bushings may be formed at opposite ends. With said bearing bushings, the bearing unit can be fastened to another component of the head-up display, in particular can be fastened in a fixed position for this purpose.

In one exemplary embodiment, the carrier is formed from plastic. It may be formed as one piece. This also means in particular that it is entirely produced in a production process. For example, it may be an injection molding component. In particular, a bearing chamber is thus formed in a single piece with the remaining part of the carrier. The bearing chamber has a cavity which is bounded by the at least two bearing walls. The bearing journal is then arranged in said cavity in the mounted end state. In addition to the two bearing walls mentioned above, which comprise the bearing journal receptacles, the bearing chamber may be bounded by further walls. These can also be side walls, as are the bearing walls mentioned with the bearing journal receptacles. In addition, the bearing chamber may also be bounded by a bottom wall in one exemplary embodiment. In one exemplary embodiment, the bearing chamber is open on the rear side facing away from the mirror. In particular, said rear side faces the bearing unit.

In one exemplary embodiment, the carrier is connected to the mirror by an adhesive element. The adhesive element is arranged in particular directly on the rear side of the mirror. It therefore lies with a front side directly against said rear side. In one exemplary embodiment, the adhesive element with a rear side facing away from the mirror is directly connected to the carrier. It then lies directly against a front side of the carrier. In one exemplary embodiment, the adhesive element is a double-sided adhesive tape.

A further aspect of the invention relates to a head-up display for a motor vehicle. The head-up display has at least one mirror device according to the abovementioned aspect or an advantageous exemplary embodiment thereof. The mirror device is arranged in particular in a housing of the head-up display. It can be a first mirror device. If the head-up display has two separate mirror devices, the first mirror device and/or the second mirror device may be formed according to the abovementioned aspect or an advantageous exemplary embodiment thereof. In particular, the head-up display is a windshield head-up display. This means that the image generated by the head-up display or the light beams emitted from it are projected directly onto a windshield of the motor vehicle.

Another aspect of the invention relates to a motor vehicle with a head-up display according to the abovementioned aspect or an advantageous exemplary embodiment thereof.

A further aspect of the invention also relates to a motor vehicle having such a head-up display.

Exemplary embodiments of the invention will be discussed in more detail below on the basis of schematic drawings. In the drawings:

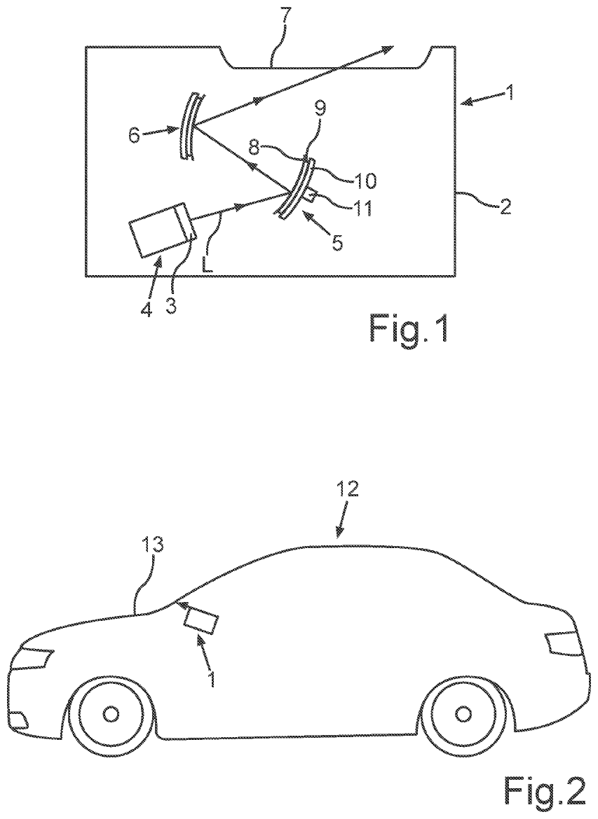

FIG. 1 shows a schematic illustration of an exemplary embodiment of a head-up display according to the invention with an exemplary embodiment of a mirror device according to the invention;

FIG. 2 shows a schematic illustration of an exemplary embodiment of a motor vehicle according to the invention;

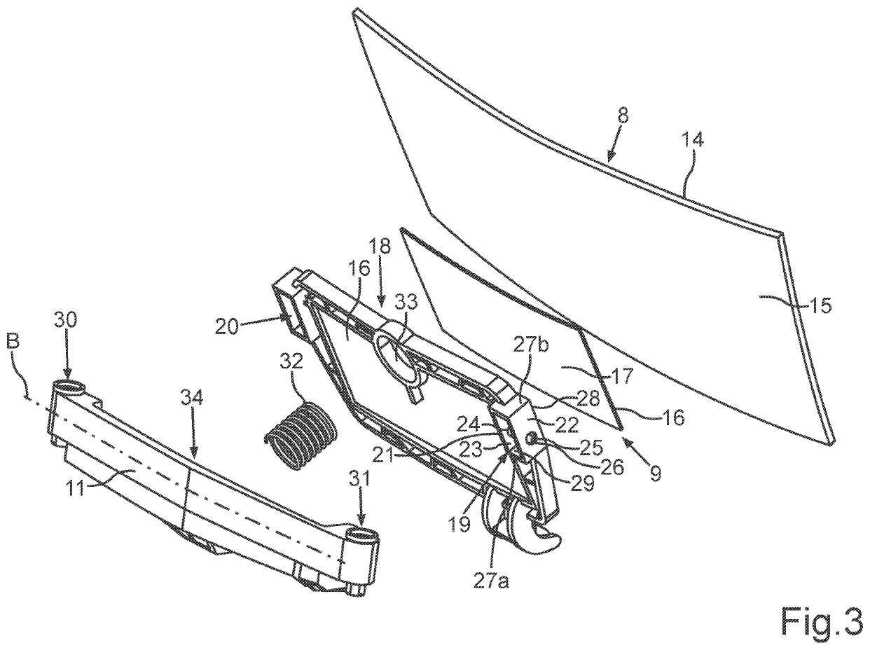

FIG. 3 shows an exploded view of an exemplary embodiment of a mirror device according to the invention;

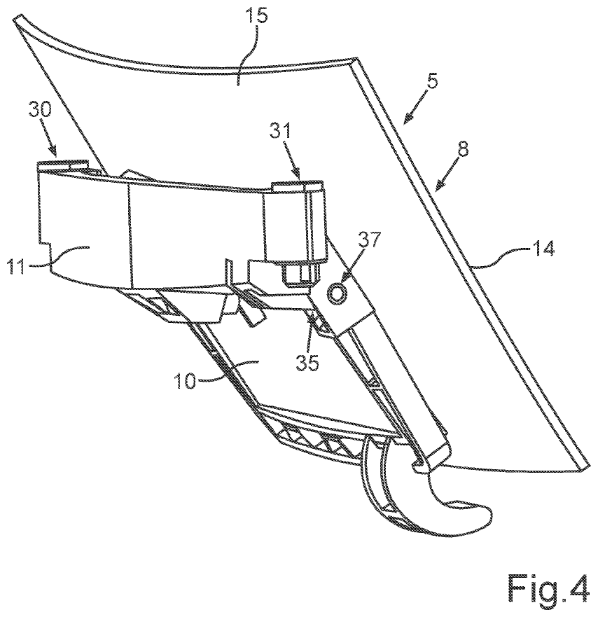

FIG. 4 shows the mirror device according to FIG. 3 in the assembled state;

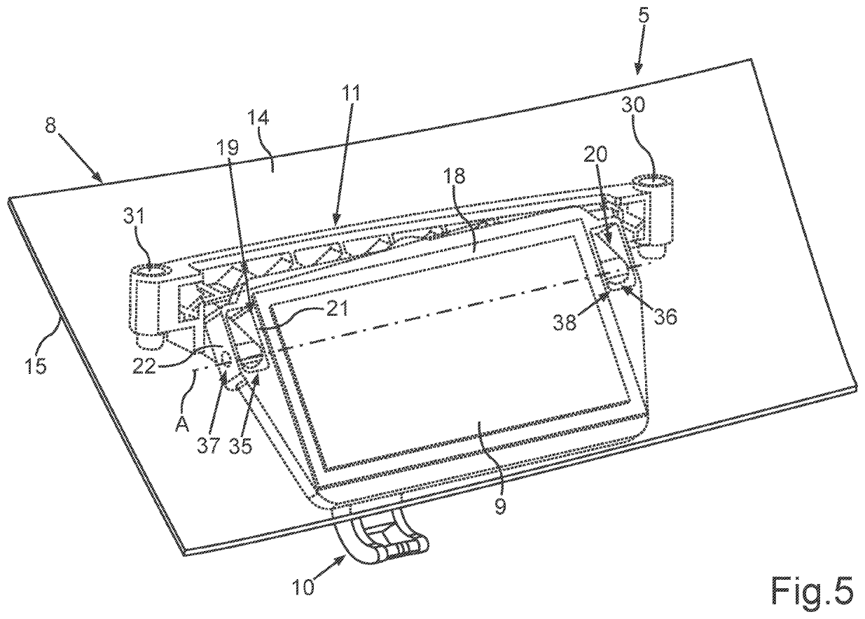

FIG. 5 shows the illustration according to FIG. 4 in a different perspective from FIG. 4;

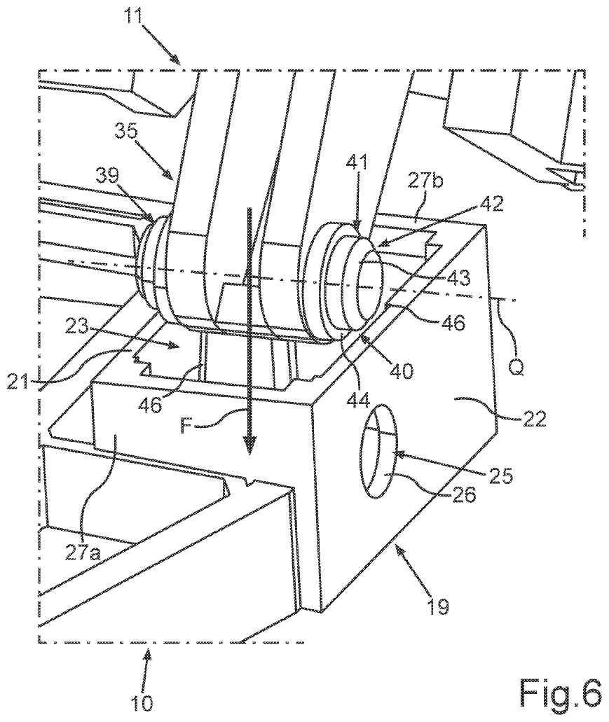

FIG. 6 shows an enlarged illustration of partial components of the mirror device in the decoupled state;

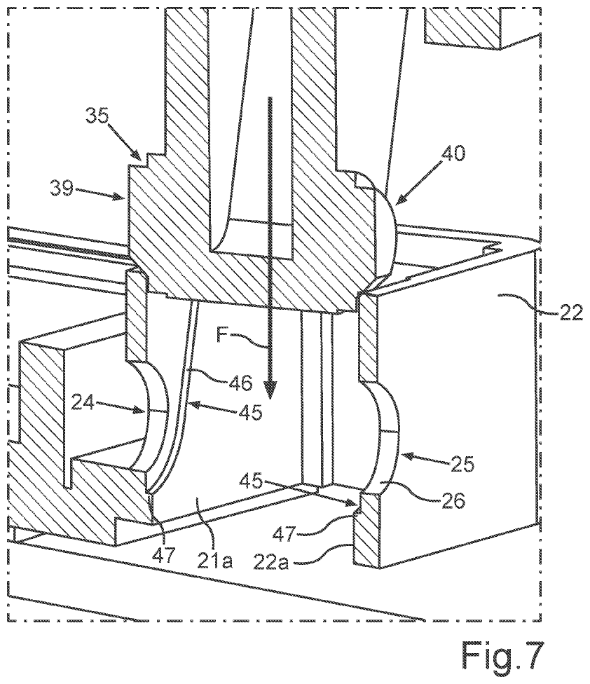

FIG. 7 shows a perspective sectional illustration through the illustration in FIG. 6;

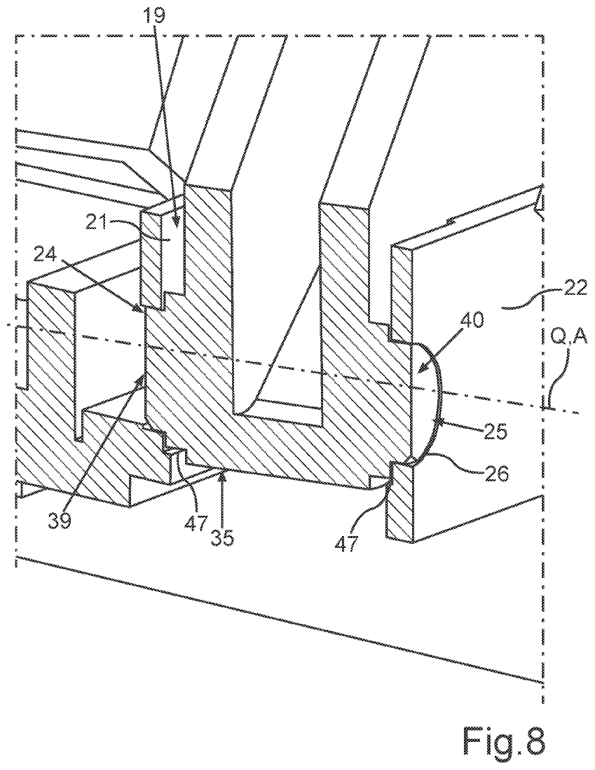

FIG. 8 shows a perspective sectional illustration of the components according to FIG. 7 in a coupled state;

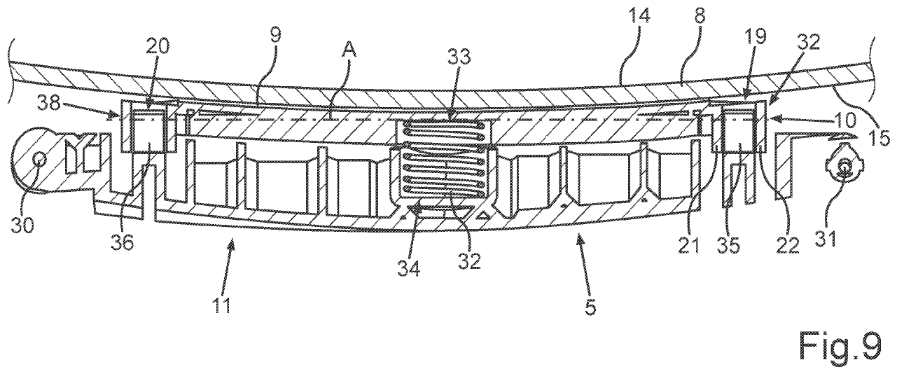

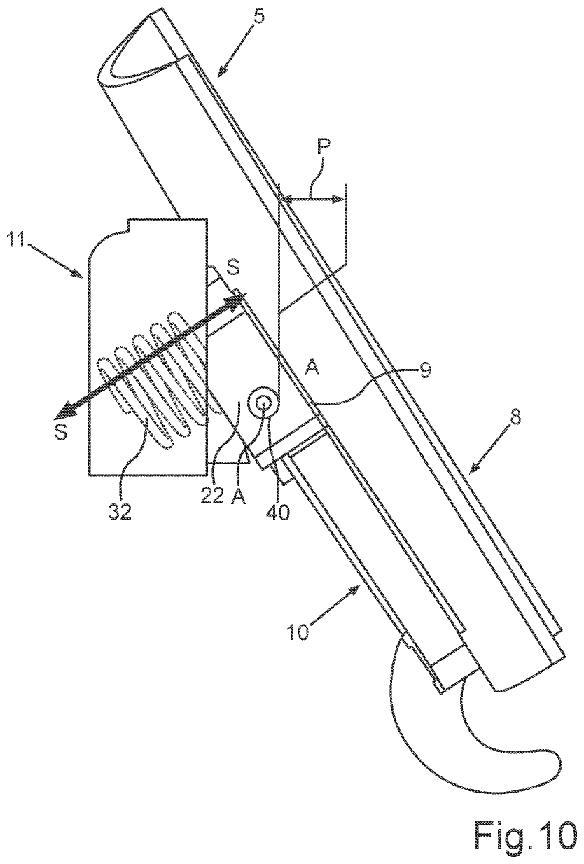

FIG. 9 shows a horizontal sectional illustration through the mirror device according to FIG. 3 to FIG. 8; and FIG. 10 shows a partially transparent side view of the mirror arrangement according to FIG. 3 to FIG. 9.

In the figures, identical or functionally identical elements are provided with the same reference signs.

In FIG. 1, an exemplary embodiment of a head-up display 1 is shown in a schematic illustration. The head-up display 1 is provided as specified for installation in a motor vehicle. The head-up display 1 here is a windshield head-up display.

The head-up display 1 has a housing 2. In a schematic illustration, at least one image generation unit 4, in particular with a display 3, is arranged in the housing 2. In addition, the head-up display 1 has a mirror device 5. In one exemplary embodiment, the head-up display 1 may have only the one mirror device 5. In another exemplary embodiment, shown here in FIG. 1, the head-up display 1 may have a further mirror device 6. The one mirror device, also referred to as first mirror device 5, is arranged in the beam path of the light L, which is radiated from the image generation unit 4, in front of the further mirror device, referred to as second mirror device 6. The light L of the image generation unit 4 is reflected from the first mirror device 5 to the second mirror device 6. The light L is then reflected from the second mirror device 6 to an exit window 7 and exits from the housing 2 there.

In one exemplary embodiment, a mirror device of a head-up display 1 has a mirror, an adhesive element and a carrier. These components may be provided in the first mirror device 5. They may also be provided additionally or instead in the second mirror device 6.

For example, the first mirror device 5 may have a mirror 8, an adhesive element 9 and a carrier 10. The mirror 8 is a reflection element.

As can also be seen in FIG. 1, the carrier 10 can be arranged mounted rotatably on a bearing unit 11 of the mirror device 5. The same may also be provided additionally or instead in the preferably present further mirror device 6.

FIG. 2 shows an exemplary embodiment of a motor vehicle 12 in a schematic illustration. The motor vehicle 12 may be, for example, a passenger car. However, it may also be a truck. The motor vehicle 12 has a head-up display 1. This is designed according to an exemplary embodiment, as has been explained with regard to FIG. 1. The light L, which exits from the exit window 7, is projected onto a windshield 13 of the motor vehicle 1.

FIG. 3 shows an exploded view of an exemplary embodiment of a mirror device. The mirror device 5 is shown here by way of example. The mirror 8, which is curved here, can be seen. It has a front side 14 and a rear side 15. The front side 14 is arranged for reflecting the light beams L. The mirror 8 is curved concavely at least on its front side 14.

In addition, the adhesive element 9 is also shown in FIG. 3. Here, it is a double-sided adhesive tape. The adhesive element 9 is in the form here of a quadrangular, in particular rectangular, shaped component. Said adhesive element 9 is directly adhesively bonded with a front side 16 to the rear side 15. The adhesive element 9 is directly connected, in particular adhesively bonded, with a rear side 17 to a front side 18 of the carrier 10. The carrier 10 may be formed in one piece. It can be produced in this context as a plastics component, in particular as an injection molding component. In the exemplary embodiment, the carrier 10 has a first bearing chamber 19. Opposite in the transverse direction, the carrier 10 has a further bearing chamber 20 which is separate here. The bearing chambers 19 and 20 are provided as specified for the purpose of receiving and mounting a respective bearing journal, not shown. As is shown in the exemplary embodiment, the bearing chamber 19 is formed with bearing walls 21 and 22, which bound a bearing cavity 23. The two bearing walls 21 and 22 are arranged spaced apart and parallel to each other. They are side walls of said bearing chamber 19. In the inner bearing wall 21, when viewed in the width direction, a bearing journal receptacle 24 is formed. The bearing journal receptacle 24 here is a continuous hole. In addition, a further bearing journal receptacle 25 is formed in the further bearing wall 22, which here is an outer bearing wall. This bearing journal receptacle 25 is also in the form of a continuous hole in the exemplary embodiment. As can be seen in the exemplary embodiment, the bearing journal receptacles 24 and 25 are peripherally delimited, namely in each case delimited by a peripherally closed contour edge. FIG. 3 shows the peripherally closed contour edge 26 of the bearing journal receptacle 25 in this regard. The bearing journal receptacles 24 and 25 are in the form here of continuous holes in the bearing walls 21 and 22. In addition, it is provided in the exemplary embodiment that the bearing chamber 19 has further side walls as boundary walls. These are the further bearing walls 27a and 27b. The previously mentioned bearing walls 21 and 22 are also side walls. It is also possible, in one exemplary embodiment, that the bearing chamber 19 also has a bottom wall 28. As a result, it is then at least partially closed toward the adhesive element 9 and/or toward the mirror 8. The bearing chamber 19 has a bearing chamber opening 29, as viewed to the rear and thus on the side facing away from the mirror 8. This represents the inlet or the corresponding opening in order to be able to insert the bearing journal. The explanations, as have been presented with regard to the bearing chamber 19, apply, in one exemplary embodiment, in particular also to the further second bearing chamber 20.

In addition, the bearing unit 11 is also shown in FIG. 3. It is designed here as an elongate rail or as an elongate beam. When viewed in the direction of its longitudinal axis B, it has bearing bushings 30 and 31 at the opposite ends. By means of said bearing bushings 30 and 31, the bearing unit 11 can be fastened to another component of the head-up display 1. In particular, a fixed attachment may be provided here.

In addition, said mirror device 5 in the exemplary embodiment shown has a spring 32. The spring 32 here is a spiral spring. It is connected so as to be coupled to the carrier 10 and to the bearing unit 11 which is separate therefrom. For this purpose, it engages, in one exemplary embodiment, in a receptacle 33 on the rear side of the carrier 10. Accordingly, the bearing unit 11, in one exemplary embodiment, has, on a front side, a further receptacle 34, in which the spring 32 is received. By means of the spring 32, the position between the bearing unit 11 and the carrier 10 can be additionally adjusted or the support thereby provided. A certain mounting state, which is preloaded by the spring, between the two components is also made possible.

In FIG. 4, the assembled state of the mirror device 5 according to the individual components in FIG. 3 is shown in a perspective illustration. As can be seen here, the bearing unit 11 is directly coupled to the carrier 10. For this purpose, a first bearing journal 35 of the bearing unit 11 engages in the bearing chamber 19. In addition, and not visible in FIG. 4, a second bearing journal 36 (FIG. 5) is arranged engaging in the further bearing chamber 20. Thus, in the exemplary embodiment, in each case at least one rotary bearing 37 and 38 (FIG. 5) is formed, with which the bearing unit 11 and the carrier 10 are directly connected rotatably to each other.

FIG. 5 shows the assembled state of the mirror device 5 in a different perspective from FIG. 4. FIG. 5 illustrates the mirror device 5 looking onto the front side 14 of the mirror 8. The components arranged behind it are also shown in this context, with the mirror 8 being shown transparently here. An axis of rotation A can also be seen in FIG. 5. The axis of rotation A is the axis of rotation of the rotary bearing 37. It is additionally also the axis of rotation of the rotary bearing 38. In the exemplary embodiment shown here with the two rotary bearings 37 and 38, a single common axis of rotation A is thus formed, which runs through the rotary bearings 37 and 38. A relative adjustment between the bearing unit 11 and the carrier 10 about said axis of rotation A is thus made possible. Since the mirror 8 is connected to the carrier 10 for conjoint rotation, a position adjustment of the mirror 8 relative to the bearing unit 11 about said rotary bearings 37 and 38 is thus also made possible.

As can be seen in FIG. 5, in this exemplary embodiment, it is provided in each case that the bearing chambers 19 and 20 are open on the side facing the mirror 8. Possible bottom walls 28 are therefore not provided in this exemplary embodiment.

FIG. 6 shows, in an enlarged illustration, the bearing chamber 19 and the bearing journal 35 which is still decoupled therefrom. The bearing journal 35 has end-side bearing pins 38 and 40 in the direction of its transverse axis Q. These are arranged opposite each other in the direction of said transverse axis Q and are oriented in a freely protruding manner in different directions. Said bearing pins 39 and 40 are provided as specified to engage in the bearing journal receptacles 24 and 25 in the coupled end state. In the mounted end state, the transverse axis Q is then also coaxial with the axis of rotation A.

As can be seen in FIG. 6, the bearing pin 40 has a cylindrical shape. A casing wall or a cylinder wall 41 is provided to lie against the contour edge 26 or the boundary wall of the bearing journal receptacle 25 in a form-fitting manner. In the exemplary embodiment, the bearing pin 40 is tapered at its outer end 42. For this purpose, a conical section 43 is formed. In one exemplary embodiment, it may be provided that at least one bearing pin, as can be seen here, for example, in the case of the bearing pin 40, has a stop 44. This stop 44 limits the immersion depth, as measured in the direction of the axis of rotation A, of the bearing pin 40 into the bearing journal receptacle 25. This stop 44 is thus perpendicular to the transverse axis Q and thus also in the mounted end state protrudes radially over the hole width of the bearing journal receptacle 25, when viewed perpendicularly to the axis of rotation A.

In one exemplary embodiment, the other bearing journal 39 is formed accordingly, as has been explained with regard to the bearing pin 40. Starting from the decoupled position shown in FIG. 6 between the bearing journal 35 and the bearing walls 21 and 22, the installation is carried out in such a way that the bearing journal 35 is introduced through the bearing chamber opening 23 into the bearing chamber 19. Owing to the dimensions of the bearing journal 35, which are measured in the direction of the transverse axis Q and which are larger than the clear width between the bearing walls 21 and 22, it is provided, in one exemplary embodiment, in the event of a corresponding insertion force F that the bearing walls 21 and 22 are pushed elastically outward. Said elastic deformability of the bearing walls 21 and 22, which are oriented in particular parallel to each other, also enables a simple installation concept.

It is preferably provided that a guide device 45 is integrally formed on an inside 21a and/or on an inside 22a of the bearing walls 21 and 22. This is provided as specified for guiding the bearing journal 35 when inserting it into the bearing chamber 19. The guide device 45 preferably has guide edges 46 by way of which the bearing journal 35 is guided from a movement in the volume space 23. In one exemplary embodiment, it is provided that the guide device 45 also has an end edge 47 which predetermines the inserted end position of the bearing journal 35 in the bearing chamber 19. In this end position, the effect is then also automatically achieved that the bearing journal 35 with its bearing pins 39 and 40 is clipped into the bearing journal receptacles 24 and 25. In this context, the bearing pins 39, 40 are also in the form of clip-in elements in this concept. Thus, the entire bearing journal 35 is also in the form of a clip-in element. By means of this guide device 45, both the finding of the end position of the bearing journal 35 in the bearing chamber 19 can be purposefully achieved, while said adjusted end position is then also additionally supported. Owing to the tapered configuration of the outer ends of the bearing pins 39 and 40, it is possible, as already indicated in FIG. 7, for a jamming-free sliding-in action to take place when they are inserted into the bearing chamber 19. Thus, the bearing walls 21 and 22 are also continuously pushed outward, and the bearing journal 35 can be more easily inserted into this cavity 23. In addition, these tapered outer ends also permit easier and more jamming-free and spreading-free sliding of the bearing pins 39 and 40 into the bearing journal receptacles 24 and 25.

FIG. 8 then shows the arrangement according to FIG. 7 in a perspective sectional illustration, wherein the bearing journal 35 is then shown here in its snapped-in or clipped-in end position in the bearing chamber 19. The axial clipping-in of the bearing pins 39, 40, thus taking place in the direction of the axis of rotation A, into bearing journal receptacles 24, 25 is produced. The, in particular completely peripheral, form-fitting bearing of the casing wall or the cylinder wall of the bearing pins 39 and 40 against the contour edges 26 of the bearing journal receptacles 24 and 25 can be seen. In the exemplary embodiment, it is provided that the bearing pins 39 and 40 do not protrude to the side over the bearing journal receptacles 24 and 25. Rather, they extend at most over the entire thickness of the bearing walls 21 and 22 into the bearing journal receptacles 24 and 25.

In FIG. 9, the mirror arrangement 5 is shown in a horizontal sectional illustration. The position of the spring 32 can be seen. The spring 32 is also used in this context virtually as a sandwich component between the carrier 10 and the bearing unit 11. If the carrier 10 rotates about the axis of rotation A relative to the bearing unit 11, the distance between these two components in the region of the receptacles 33 and 34 is changed. In this context, the spring 32 then also changes its length in this regard, and therefore the spring 32 is compressed or relaxed. This also generates a spring force S, as is shown by way of example in FIG. 10.

FIG. 10 shows the mirror device 5 from the side, with the region with the spring 32 being shown transparently. Said spring 32, when actuated, is then used to compensate for a play P, which may arise due to the mechanical design and manufacturing and position tolerances between the carrier 10 and the bearing unit 11. Thus, in this exemplary embodiment too, a virtually tolerance-free rotational movement is assisted.

By means of the at least one rotary bearing 37 and/or 38, the effect is achieved that at least one bearing journal 35 is arranged between the associated, spaced-apart and separate bearing walls 21 and 22 in the bearing chamber 19 and engages in bearing journal receptacles 24 and 25 such that the bearing journal 35 is mounted directly rotatably on both bearing walls 21 and 22 and thus arranged virtually between the bearing walls 21 and 22 in the direction of the axis of rotation A and is snapped or clipped together with said bearing walls. In this context, the clipping together is carried out in the direction of the axis of rotation A.

1. A mirror device for a head-up display,
the mirror device comprising:
a mirror;
a carrier which is arranged on a rear side of the mirror and is fixedly connected to the mirror; and
a bearing unit which is separate from the carrier,
wherein the bearing unit is connected to the carrier by at least one rotary bearing, and
wherein the carrier and the bearing unit when coupled by the rotary bearing are rotatable relative to each other,
wherein the rotary bearing comprises at least one bearing journal and at least one bearing chamber with opposite bearing walls,
wherein the bearing journal is arranged between the bearing walls of the bearing chamber and engages in bearing journal receptacles, which are formed in the bearing walls, such that the bearing journal is rotatably mounted on both bearing walls and an axis of rotation of the rotary bearing runs through the bearing journal receptacles.

2. The mirror device as claimed in claim 1,
wherein the bearing journal receptacles are in the form of continuous holes in the bearing walls with an in each case peripherally closed contour edge.

3. The mirror device as claimed in claim 1,
wherein the bearing walls are elastically deformable in the direction of the axis of rotation.

4. The mirror device as claimed in claim 3,
wherein, when viewed in the direction of the axis of rotation, the bearing journal has comprises end-side bearing pins that extend in the direction of the axis of rotation into the bearing journal receptacle.

5. The mirror device as claimed in claim 4,
wherein the bearing pins are received in the bearing journal receptacles in a form-fitting manner.

6. The mirror device as claimed in claim 4,
wherein the bearing pins are cylindrical and lie with cylinder walls against the contour edges of the bearing journal receptacles in a form-fitting manner.

7. The mirror device as claimed in claim 4,
wherein at least one bearing pin is tapered at its outer end.

8. The mirror device as claimed in claim 4,
wherein at least one bearing pin comprises a stop which limits the immersion depth, as measured in the direction of the axis of rotation, of the bearing pin into a bearing journal receptacle.

9. The mirror device as claimed in claim 1,
wherein a guide device for guiding the bearing journal when it is inserted into the bearing chamber is formed on an inside of at least one bearing wall.

10. The mirror device as claimed in claim 9,
wherein the guide device comprises an end edge which predetermines the end position of the bearing journal in the bearing chamber,
wherein, in the end position, the bearing journal is clipped into the bearing journal receptacles.

11. The mirror device as claimed in claim 1,
wherein the bearing journal is in the form of a clip-in element which is clipped axially into the bearing journal receptacles.

12. The mirror device as claimed in claim 11,
wherein the mirror device comprises a spring which is arranged between the carrier and the bearing unit such that a position between the carrier and the bearing unit is preloaded by the spring.

13. The mirror device as claimed in claim 1,
wherein the mirror device comprises two separate rotary bearings, which are arranged spaced apart from each other and are constructed identically, with the axis of rotation running through both rotary bearings.

14. A head-up display with a mirror device as claimed in claim 1.

15. A motor vehicle with a head-up display as claimed in claim 14.
